(19) United States
(12) Patent Application Publication
(10) Pub. No.: US 2020/0148844 A1
(43) Pub. Date: May 14, 2020

(54) POLYIMIDE FILM MANUFACTURING METHOD

(71) Applicant: TAIMIDE TECH. INC., Hsinchu (TW)

(72) Inventors: Yi-Hsueh Ho, Hsinchu (TW); Yi-Ting Liu, Hsinchu (TW)

(21) Appl. No.: 16/671,251

(22) Filed: Nov. 1, 2019

(30) Foreign Application Priority Data
Nov. 14, 2018 (TW) 107140386

(51) Int. Cl. C08J 5/18; C08G 73/10; B01J 31/02

(52) U.S. Cl. CPC C08J 5/18; C08G 73/1067; C08J 2379/08; B01J 31/0244; C08G 73/1021

(57) ABSTRACT

The present disclosure relates to a method for producing a polyimide film. The method includes: providing a polyamic acid copolymer including at least a semi-aromatic polyamic acid obtained by reacting cyclobutane-1,2,3,4-tetracarboxylic (CBDA) with an aromatic cyclic diamine; and adding dehydrating agent and a pyridine catalyst having an ortho substituent into the polyamic acid copolymer to carry out a chemical imidization reaction of the polyamic acid copolymer to prepare a polyimide film.

CROSS-REFERENCE TO RELATED PATENT APPLICATION

This application claims the benefit of priority to Taiwan Patent Application No. 107140386, filed on Nov. 14, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyimide film manufacturing method, and more particularly to a manufacturing method for a polyimide film having better mechanical properties and a more convenient manufacturing process.

### BACKGROUND OF THE DISCLOSURE

Polyimide film is produced by imidization reaction of a precursor polyamic acid of polyimide, and the imidization reaction is performed with either chemical cyclization or thermal cyclization. Thermal cyclization is the imidization of polyamic acid precursor under high temperature conditions, while chemical cyclization uses dehydrating agents and catalysts to allow polyamic acid precursor to reach partial imidization at lower temperatures, and then the polyamic acid precursor is baked at a high temperature to make the imidization more complete. Thermal cyclization requires more baking time in production, and also causes a decrease in the mechanical properties of the polyimide film and yellowing of the color under long-time baking. The chemical cyclization process is fast and maintains good mechanical properties, so that chemical cyclization is a preferred choice in mass production.

A polyimide film containing a cyclobutane-1,2,3,4-tetracarboxylic (CBDA) component has good optical and temperature resistance, and thus is often applied to a liquid crystal alignment treatment agent for a liquid crystal element, a semiconductor element, a protective film, an insulating film, or an optical waveguide material for optical communication. U.S. Pat. No. 5,053,480A discloses a polyamic acid being formed by using a CBDA to react with a diamine, and after cyclization by a thermal closed-loop method, a polyimide film having good optical penetration and heat resistance can be produced. U.S. Pat. No. 6,489,431B1 discloses that a CBDA with a constituent diamine having a hexafluoropropylene group is used, and after cyclization by a thermal closed-loop method, a polyimide film having better optical properties can be produced. The above patents adopt the thermal closed-loop method to form a film. However, since the thermal closed-loop method requires a long baking time, and the mechanical properties of the produced polyimide film are inferior to those of the film made by chemical cyclization, many researchers have attempted to produce the film by chemical cyclization. In addition, in the journal High Perform. Polym. 2001, 13, S93-S106, Hasegawa mentions that the use of polyamic acid having a CBDA component causes a solubility problem that results in precipitation by chemical cyclization. So far, in the field of chemical cyclization technology, no product based on such dianhydride has been found.

Therefore, the present disclosure provides a method for manufacturing a polyimide film having a cyclobutane-1,2,3,4-tetracarboxylic (CBDA) component by chemical cyclization, and the polyimide film produced by this method can have better mechanical properties.

### SUMMARY OF THE DISCLOSURE

In response to the above-referenced technical inadequacies, the present disclosure provides a polyimide film manufacturing method including: providing a polyamic acid copolymer including at least a semi-aromatic polyamic acid obtained by reacting cyclobutane-1,2,3,4-tetracarboxylic (CBDA) with an aromatic cyclic diamine; and adding the polyamic acid copolymer with a dehydrating agent and a pyridine catalyst having an ortho substituent to carry out a chemical imidization reaction of the polyamic acid copolymer to prepare a polyimide film.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a flow chart of a polyimide film manufacturing method of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

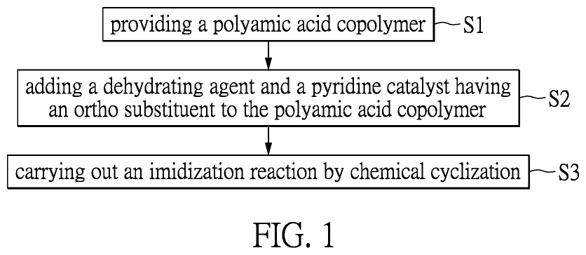

Referring to FIG. 1, a polyimide film manufacturing method of the present disclosure includes following steps: providing a polyamic acid copolymer (S1) including at least a semi-aromatic polyamic acid obtained by reacting cyclobutane-1,2,3,4-tetracarboxylic (CBDA) with an aromatic cyclic diamine; and adding a dehydrating agent and a pyridine catalyst having an ortho substituent to the polyamic acid copolymer (S2) to carry out an imidization reaction by chemical cyclization (S3) to produce the polyimide film.

The aromatic cyclic diamine of the semi-aromatic polyamic acid can be p-phenylenediamine (PDA), 4,4′-diaminodiphenyl ether (ODA), 2,2′-bis[4-(4-aminophenoxyphenyl)]propane (BAPP), 2,2′-bis(trifluoromethyl)benzidine (TFMB), 3,5-diaminobenzoic acid (35DABA), 4,4′-diaminobenzanilide (44DABA), 1-(4-aminophenyl)-2,3-dihydro-1,3,3-trimethyl-1H-inden-5-amine (TMDA), bis[4-(4-aminophenoxy)phenyl]sulfone (BAPS), 4,4′-bis(4-aminophenoxy)biphenyl (BAPB), 1,4-bis(4-aminophenoxy)benzene (TPEQ), 2,2′-bis(trifluoromethyl)-4,4′-diaminophenyl ether (6FODA), 2,2-bis[4-(4-aminophenoxy)phenyl]-1,1,1,3,3,3-hexafluoropropane (HFBAPP), 4,4′-(9-fluorenylidene)dianiline (BAFL), 2-(4-aminophenyl)-5-aminobenzoxazole (5BPOA), m-phenylenediamine (mPDA), 4,4′-diaminodiphenyl sulfone (44DDS), 2,2-bis(4-aminophenyl)hexafluoropropane (Bis-A-AF), 2,2-bis(3-amino-4-hydroxylphenyl) hexafluoropropane (6FAP), or 4,4′-[1,4-phenylbis (oxy)]bis[3-(trifluoromethyl)aniline] (FAPB).

The polyamic acid copolymer can include an aromatic polyamic acid obtained by reacting an aromatic diamine with an aromatic dianhydride. The aromatic diamine includes 2,2′-bis(trifluoromethyl)benzidine (TFMB), 2,2′-bis[4-(4-aminophenoxyphenyl)]propane(BAPP), 2,2-bis[4-(4-aminophenoxy)phenyl]-1,1,1,3,3,3-hexafluoropropane (HFBAPP), 1-(4-aminophenyl)-2,3-dihydro-1,3,3-trimethyl-1H-inden-5-amine (TMDA), p-phenylenediamine (PDA), 4,4′-bis(4-aminophenoxy)biphenyl (BAPB), 2,2′-bis(trifluoromethyl)-4,4′-diaminophenyl ether (6FODA), bis[4-(4-aminophenoxy)phenyl]sulfone (BAPS), 4,4′-(9-fluorenylidene)dianiline (BAFL), 4,4′-diaminodiphenyl sulfone (44DDS), 4,4′-diaminodiphenyl ether (ODA), 4,4′-diaminobenzanilide (44DABA), 2,2-bis(4-aminophenyl)hexafluoropropane (Bis-A-AF), m-phenylenediamine (mPDA), 2,2-bis(3-amino-4-hydroxylphenyl) hexafluoropropane (6FAP), 3,5-diaminobenzoic acid (35DABA), 2-(4-aminophenyl)-5-aminobenzoxazole (5BPOA), 1,4-bis(4-aminophenoxy)benzene (TPEQ), and 4,4′-[1,4-phenylbis(oxy)]bis[3-(trifluoromethyl)aniline] (FAPB). The aromatic dianhydride includes 1,2,4,5-benzenetetracarboxylic dianhydride (PMDA), 3,3′,4,4′-biphenyltetracarboxylic dianhydride (BPDA), 4,4′-oxydiphthalic anhydride (ODPA), 3,3′,4,4′-benzophenonetetracarboxylic dianhydride (BTDA), 3,3′,4,4′-diphenylsulfonetetracarboxylic dianhydride (DSDA), 2,3,3′,4′-biphenyltetracarboxylic dianhydride (α-BPDA), 4,4-hexafluoroisopropyl phthalic anhydride (6FDA) and 4,4′-(4,4′-isopropyldiphenoxy)diphthalic anhydride (BPADA).

The polyamic acid copolymer is subjected to chemical cyclization for imidization reaction, the dehydrating agent and the pyridine catalyst having the ortho substituent are added. The pyridine catalyst having the ortho substituent may have the following structure:

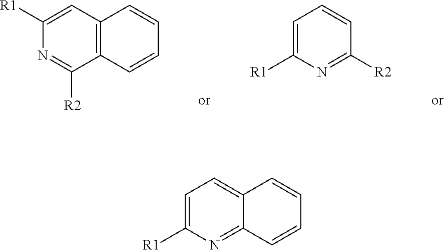

At least one of R1 and R2 is a non-hydrogen substituent, and a number of moles of the pyridine catalyst having the ortho substituent is greater than or equal to a number of moles of the polyamic acid copolymer.

### Testing Method

Elongation: Measurements are performed using a Hounsfield H10K-S tensile machine in accordance with ASTM D882.

### First Embodiment

### Manufacture of Polyamic Acid Copolymer

42.972 grams of 2,2′-bis(trifluoromethyl)benzidine (TFMB, 0.1342 mole, mole fraction 0.625 in diamine solution) is added to 412.5 grams of N,N-dimethylacetamide (DMAc), and after completely dissolving, 21.053 g of cyclobutane-1,2,3,4-tetracarboxylic (CBDA, 0.1074 mole, mole fraction 0.5 in anhydride) is added. The reaction is stirred for six hours and the temperature is maintained at 25° C.

25.783 g of TFMB (0.0805 mole) is added to the solution and stirred until being fully dissolved. 47.691 g of 6FDA (0.1074 mole) is added, and the solution is stirred and reacted for a certain period of time, and then stirred for a certain time under a constant temperature of 25° C. to obtain a 25% solid content polyamic acid copolymer solution.

### Manufacture of Polyimide Film

57 g of the above polyamic acid copolymer solution is taken, and the solid content is diluted to 17.8% using N,N-dimethylacetamide (DMAc). 12.6 ml of acetic anhydride and 19.5 ml of 2-methylpyridine are added respectively, and after uniform stirring, the solution is coated on a glass plate with a scraper having a gap of 900 μm. A coated sample is placed in a 50° C. oven for 20 minutes, slowly heated to 170° C. and then heated for 20 minutes. The temperature is raised to 260° C. and then heated for 20 minutes for final treatment to form a polyimide film.

The polyimide film obtained above has an elongation of 26%.

### Second Embodiment

### Manufacture of Polyamic Acid Copolymer

20.100 grams of 2,2′-bis(trifluoromethyl)benzidine (TFMB, 0.0627 mole, mole fraction 0.315 in diamine solution) is added to 412.5 grams of N,N-dimethylacetamide (DMAc), and after completely dissolving, 11.723 g of cyclobutane-1,2,3,4-tetracarboxylic (CBDA, 0.0598 mole, mole fraction 0.3 in anhydride) is added. The solution is stirred for six hours and the temperature is maintained at 25° C.

43.711 g of TFMB (0.1365 mole) is added to the solution and stirred until fully dissolved. 61.965 g of 6FDA (0.1395 mole) is added, and the solution is stirred and reacted for a certain period of time, and then stirred for a certain time under a constant temperature of 25° C. to obtain a 25% solid content polyamic acid copolymer solution.

### Manufacture of Polyimide Film

57 g of the above polyamic acid copolymer solution is taken, and the solid content is diluted to 17.8% using N,N-dimethylacetamide (DMAc). 11.7 ml of acetic anhydride and 4 ml of 2-methylpyridine are added respectively, and after uniform stirring, the solution is coated on a glass plate with a scraper having a gap of 900 μm. A coated sample is placed in a 50° C. oven for 20 minutes, slowly heated to 170° C. and then heated for 20 minutes. The temperature is raised to 260° C. and then heated for 20 minutes for final treatment to form a polyimide film.

The polyimide film obtained above has an elongation of 12%.

### COMPARATIVE EXAMPLE 1

### Manufacture of Polyamic Acid Copolymer

42.972 grams of 2,2′-bis(trifluoromethyl)benzidine (TFMB, 0.1342 mole, mole fraction 0.625 in diamine solution) is added to 412.5 grams of N,N-dimethylacetamide (DMAc), and after completely dissolving, 21.053 g of cyclobutane-1,2,3,4-tetracarboxylic (CBDA, 0.1074 mole, mole fraction 0.5 in anhydride) is added. The reaction is stirred for six hours and the temperature is maintained at 25° C.

25.783 g of TFMB (0.0805 mole) is added to the solution and stir until fully dissolved. 47.691 g of 6FDA (0.1074 mole) is added, and the solution is stirred and reacted for a certain period of time, and then stirred for a certain time under constant temperature of 25° C. to obtain a 25% solid content polyamic acid copolymer solution.

### Manufacture of Polyimide Film

57 g of the above polyamic acid copolymer solution is taken, and the solid content is diluted to 17.8% using N,N-dimethylacetamide (DMAc). 12.6 ml of acetic anhydride and 4.3 ml of 3-methylpyridine are added respectively. After stirring, rapid gelation occurs, so that film formation is impossible.

### COMPARATIVE EXAMPLE 2

### Manufacture of Polyamic Acid Copolymer

42.972 grams of 2,2′-bis(trifluoromethyl)benzidine (TFMB, 0.1342 mole, mole fraction 0.625 in diamine solution) is added to 412.5 grams of N,N-dimethylacetamide (DMAc), and after completely dissolving, 21.053 g of cyclobutane-1,2,3,4-tetracarboxylic (CBDA, 0.1074 mole, mole fraction 0.5 in anhydride) is added. The reaction is stirred for six hours and the temperature is maintained at 25° C.

25.783 g of TFMB (0.0805 mole) is added to the solution and stir until fully dissolved. 47.691 g of 6FDA (0.1074 mole) is added, and the solution is stirred and reacted for a certain period of time, and then stirred for a certain time under constant temperature of 25° C. to obtain a 25% solid content polyamic acid copolymer solution.

### Manufacture of Polyimide Film

57 g of the above polyamic acid copolymer solution is taken, and the solid content is diluted to 17.8% using N,N-dimethylacetamide (DMAc). The solution is coated on a glass plate with a scraper having a gap of 900 μm. A coated sample is placed in a 50° C. oven for 20 minutes, slowly heated to 170° C. and then heated for 20 minutes. The temperature is raised to 260° C. and then heated for 20 minutes for final treatment to form a polyimide film.

The polyimide film obtained above has a physical property that is fragile, and it is impossible to measure its elongation.

### COMPARATIVE EXAMPLE 3

### Manufacture of Polyamic Acid Copolymer

20.100 grams of 2,2′-bis(trifluoromethyl)benzidine (TFMB, 0.0627 mole, mole fraction 0.315 in diamine solution) is added to 412.5 grams of N,N-dimethylacetamide (DMAc), and after completely dissolving, 11.723 g of cyclobutane-1,2,3,4-tetracarboxylic (CBDA, 0.0598 mole, mole fraction 0.3 in anhydride) is added. The reaction is stirred for six hours and the temperature is maintained at 25° C.

43.711 g of TFMB (0.1365 mole) is added to the solution and stir until fully dissolved. 61.965 g of 6FDA (0.1395 mole) is added, and the solution is stirred and reacted for a certain period of time, and then stirred for a certain time under constant temperature of 25° C. to obtain a 25% solid content polyamic acid copolymer solution.

### Manufacture of Polyimide Film

57 g of the above polyamic acid copolymer solution is taken, and the solid content is diluted to 17.8% using N,N-dimethylacetamide (DMAc). The solution is coated on a glass plate with a scraper having a gap of 900 μm. A coated sample is placed in a 50° C. oven for 20 minutes, slowly heated to 170° C. and then heated for 20 minutes. The temperature is raised to 260° C. and then heated for 20 minutes for final treatment to form a polyimide film.

The polyimide film obtained above has an elongation of 2%.

Experimental comparison table

| | semi-aromatic | | | | | | |
|---|---|---|---|---|---|---|---|
| | polyamic acid | | | | film- | | |
| | | aromatic | | | forming | elongation | thickness |
| | | polyamic acid | | catalyst | ability | % | μm |
| Embodiment 1 | CBDA | TFMB | 6FDA | 2- | ◯ | 26 | 50 |
| | 50 | 100 | 50 | (mol %)methylpyridine | | | |
| Embodiment 2 | CBDA | TFMB | 6FDA | 2- | ◯ | 12 | 50 |
| | 30 | 100 | 70 | (mol %)methylpyridine | | | |
| Comparative | CBDA | TFMB | 6FDA | 3- | X | — | — |
| Example 1 | 50 | 100 | 50 | (mol %)methylpyridine | | | |
| Comparative | CBDA | TFMB | 6FDA | (mol %) none | ◯ | embrittlement | 50 |
| Example 2 | 50 | 100 | 50 | | | | |
| Comparative | CBDA | TFMB | 6FDA | (mol %) none | ◯ | 2 | 50 |
| Example 3 | 30 | 100 | 70 | | | | |

X: Unable to form a film;
◯: Able to form a film
Pyridine catalyst with ortho substituent: 2-methylpyndme
Pyridine catalyst without ortho substituent: 3-methylpyridine

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyimide film manufacturing method comprising following steps:
providing a polyamic acid copolymer including at least a semi-aromatic polyamic acid obtained by reacting cyclobutane-1,2,3,4-tetracarboxylic (CBDA) with an aromatic cyclic diamine; and
adding a dehydrating agent and a pyridine catalyst having an ortho substituent into the polyamic acid copolymer to carry out a chemical imidization reaction of the polyamic acid copolymer to prepare a polyimide film.

2. The polyimide film manufacturing method according to claim 1, wherein the polyamic acid copolymer further includes an aromatic polyamic acid obtained by reacting an aromatic diamine with an aromatic dianhydride.

3. The polyimide film manufacturing method according to claim 1, wherein the aromatic cyclic diamine is p-phenylenediamine (PDA), 4,4′-diaminodiphenyl ether (ODA), 2,2′-bis[4-(4-aminophenoxyphenyl)]propane (BAPP), 2,2′-bis(trifluoromethyl)benzidine (TFMB), 3,5-diaminobenzoic acid (35DABA), 4,4′-diaminobenzanilide (44DABA), 1-(4-aminophenyl)-2,3-dihydro-1,3,3-trimethyl-1H-inden-5-amine (TMDA), bis[4-(4-aminophenoxy)phenyl]sulfone (BAPS), 4,4′-bis(4-aminophenoxy)biphenyl (BAPB), 1,4-bis(4-aminophenoxy)benzene (TPEQ), 2,2′-bis(trifluoromethyl)-4,4′-diaminophenyl ether (6FODA), 2,2-bis[4-(4-aminophenoxy)phenyl]-1,1,1,3,3,3-hexafluoropropane (HFBAPP), 4,4′-(9-fluorenylidene)dianiline (BAFL), 2-(4-aminophenyl)-5-aminobenzoxazole (5BPOA), m-phenylenediamine (mPDA), 4,4′-diaminodiphenyl sulfone (44DDS), 2,2-bis(4-aminophenyl)hexafluoropropane (Bis-A-AF), 2,2-bis(3-amino-4-hydroxylphenyl) hexafluoropropane (6FAP), or 4,4′-[1,4-phenylbis(oxy)]bis[3-(trifluoromethyl)aniline] (FAPB).

4. The polyimide film manufacturing method according to claim 1, wherein the structure of the pyridine catalyst having the ortho substituent is: 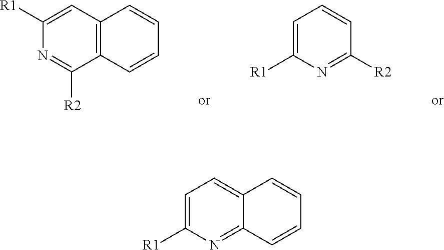
wherein, at least one of R1 and R2 is a non-hydrogen substituent.

5. The polyimide film manufacturing method according to claim 1, wherein a number of moles of the pyridine catalyst having the ortho substituent is greater than or equal to a number of moles of the polyamic acid copolymer.
